(19) United States
(12) Patent Application Publication
(10) Pub. No.: US 2006/0095730 A1
(43) Pub. Date: May 4, 2006

(54) Expansion of compute engine code space by sharing adjacent control stores using interleaved program addresses

(76) Inventors: Gilbert Wolrich, Framingham, MA (US); Mark B. Rosenbluth, Uxbridge, MA (US); Matthew J. Adiletta, Bolton, MA (US); Hugh M. Wilkinson, Newton, MA (US); Jose S. Niell, Franklin, MA (US); Rajagopal K. Narayanan, San Jose, CA (US); Sanjeev Jain, Shrewsbury, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/955,643

(22) Filed: Sep. 30, 2004

(51) Int. Cl. G06F 9/30

(52) U.S. Cl. 712/215

(57) ABSTRACT

Method and apparatus to support expansion of compute engine code space by sharing adjacent control stores using interleaved addressing schemes. Instructions corresponding to an original instruction thread are partitioned into multiple interleaved sequences that are stored in respective control stores. During thread execution, instructions are retrieved from the control stores in a repeated order based on the interleaving scheme. For example, in one embodiment two compute engines share two control stores. Thus, instructions for a given thread are sequentially loaded from the control stores in an alternating manner. In another embodiment, four control stores are shared by four compute engines. In this case, the instructions in a thread are interleave using four stores, and each store is accessed every fourth instruction in the code sequence. Schemes are also provided for handling branching operations to maintain synchronized access to the control stores.

### FIELD OF THE INVENTION

The field of invention relates generally to computer networking equipment and, more specifically but not exclusively relates to techniques for sharing computer engine code space across multiple processing elements.

### BACKGROUND INFORMATION

Network devices, such as switches and routers, are designed to forward network traffic, in the form of packets, at high line rates. One of the most important considerations for handling network traffic is packet throughput. To accomplish this, special-purpose processors known as network processors have been developed to efficiently process very large numbers of packets per second. In order to process a packet, the network processor (and/or network equipment employing the network processor) needs to extract data from the packet header indicating the destination of the packet, class of service, etc., store the payload data in memory, perform packet classification and queuing operations, determine the next hop for the packet, select an appropriate network port via which to forward the packet, etc. These operations are collectively referred to as “packet processing.”

Modern network processors perform packet processing using multiple multi-threaded processing elements (referred to as microengines or compute engines in network processors manufactured by Intel® Corporation, Santa Clara, Calif.), wherein each thread performs a specific task or set of tasks in a pipelined architecture. During packet processing, numerous accesses are performed to move data between various shared resources coupled to and/or provided by a network processor. For example, network processors commonly store packet metadata and the like in static random access memory (SRAM) stores, while storing packets (or packet payload data) in dynamic random access memory (DRAM)-based stores. In addition, a network processor may be coupled to cryptographic processors, hash units, general-purpose processors, and expansion buses, such as the PCI (peripheral component interconnect) and PCI Express bus.

In general, the various packet-processing compute engines of a network processor, as well as other optional processing elements, will function as embedded specific-purpose processors. In contrast to conventional general-purpose processors, the compute engines do not employ an operating system to host applications, but rather directly execute “application” code using a reduced instruction set. For example, the microengines in Intel's IXP2xxx family of network processors are 32-bit RISC processors that employ an instruction set including conventional RISC (reduced instruction set computer) instructions with additional features specifically tailored for network processing. Because microengines are not general-purpose processors, many tradeoffs are made to minimize their size and power consumption.

One of the tradeoffs relates to instruction store space, i.e., space allocated for storing instructions. Since silicon real-estate for network processors is limited and needs to be allocated very efficiently, only a small amount of silicon is reserved for storing instructions. For example, the compute engine control store for an Intel IXP1200 holds 2K instruction words, while the IXP2400 holds 4K instructions words, and the IXP2800 holds 8K instruction words. For the IXP2800, the 8K instruction words take up approximately 30% of the compute engine area for Control Store (CS) memory.

One technique for addressing the foregoing instruction space limitation is to limit the application code to a set of instructions that fits within the Control Store. Under this approach, each CS is loaded with a fixed set of application instructions during processor initialization, while additional or replacement instructions are not allowed to be loaded while a microengine is running. Thus, a given application program is limited in size by the capacity of the corresponding CS memory. In contrast, the requirements for instruction space continues to grow with the advancements provided by each new generation of network processors.

Another approach for increasing instruction space is to employ an instruction cache. Instruction caches are used by conventional general-purpose processors to store recently-accessed code, wherein non-cached instructions are loaded into the cache from an external memory (backing) store (e.g., a DRAM store) when necessary. In general, the size of the instruction space now becomes limited by the size of the backing store. While replacing the Control Store with an instruction cache would provide the largest increase in instruction code space (in view of silicon costs), it would need to overcome many complexity and performance issues. The complexity issues arise mostly due to the multiple program contexts (multiple threads) that execute simultaneously on the compute engines. The primary performance issues with employing a compute engine instruction cache concern the backing store latency and bandwidth, as well as the cache size. In view of this and other considerations, it would be advantageous to provide increased instruction space without significantly impacting other network processor operations.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating an instruction store sharing scheme under which two control stores are shared between two compute engines, according to one embodiment of the invention;

FIG. 2a shows an instruction sequence corresponding to an exemplary original instruction thread that is employed to illustrate how the instruction thread is interleaved under the embodiments disclosed herein;

FIG. 2b is a schematic diagram of an exemplary interleaving scheme under which even instructions for the original instruction thread of FIG. 2b are stored in a first control store, while odd instructions are stored in a second control store;

FIG. 2c shows sequences of instructions that are loaded in executed in accordance with an exemplary execution of the instruction thread using the two compute engines;

FIG. 3a is a schematic diagram illustrating the loading and execution of instructions for the two compute engines corresponding to an initial (starting) timeframe;

FIG. 3b is a schematic diagram illustrating the loading and execution of instructions for the two compute engines corresponding to an second timeframe;

FIG. 3c is a schematic diagram illustrating the loading and execution of instructions for the two compute engines corresponding to an third timeframe, the figure further illustrating an exemplary resynchronization scheme employing a no operation (NOP) instruction;

FIG. 3d is a schematic diagram illustrating the loading and execution of instructions for the two compute engines corresponding to an fourth timeframe, the figure further illustrating resumption of the instruction sequence load and execution on the second compute engine;

FIG. 4 is a schematic diagram illustrating an instruction store sharing scheme under which four control stores are shared between four compute engines, according to one embodiment of the invention;

FIG. 5 is a schematic diagram of an exemplary interleaving scheme under which every fourth instruction in the original instruction thread of FIG. 2b is stored in a corresponding control store;

FIG. 6 is a schematic diagram of a circuit architecture that may be employed to implement the control store sharing scheme of FIG. 1, according to one embodiment of the invention; and

FIG. 7 is a schematic diagram of a line card that includes a network processor that implements network processor architectures of FIGS. 1 and 6.

### DETAILED DESCRIPTION

Embodiments of methods and apparatus for expansion of compute engine code space by sharing adjacent control stores using interleaved program addresses are described herein. In the following description, numerous specific details are set forth, such as implementations using Intel IPX® network processor architectures, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

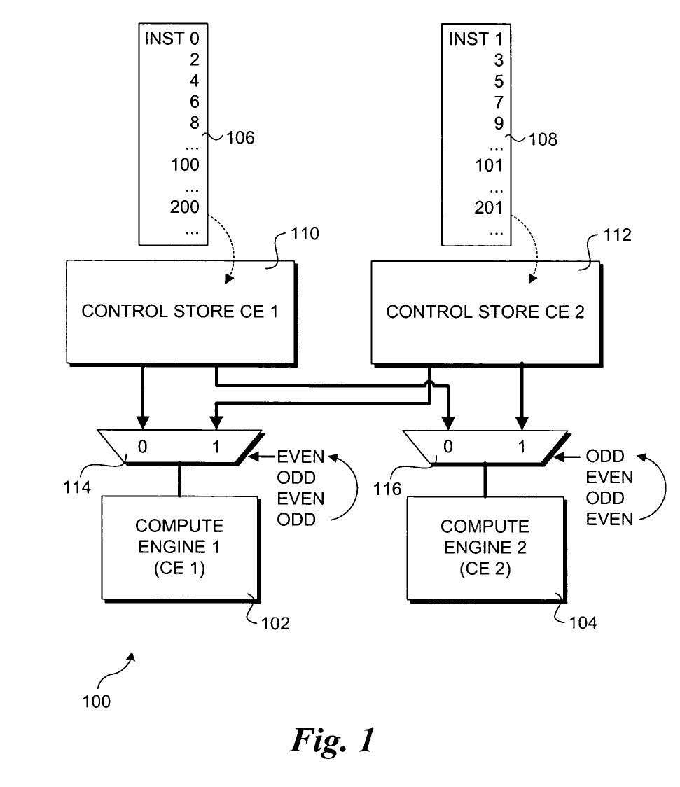

FIG. 1 shows an architecture 100 illustrating one embodiment of a scheme for sharing code stores between a pair of compute engines. Architecture 100 includes two compute engines 102 and 104, which are used to execute interleaved instructions 106 and 108 that are stored in control stores 110 and 112, respectively. Each of control stores 110 and 112 are coupled to a pair of multiplexers 114 and 116, which are employed to selectively choose from which control store a next instruction is to be loaded from based on whether the instruction is an odd instruction or an even instruction, as explained below in further detail. Furthermore, the multiplexers are illustrative of instruction load logic circuitry that is employed to select the appropriate instructions and control stores from which such instructions are loaded into the compute engines.

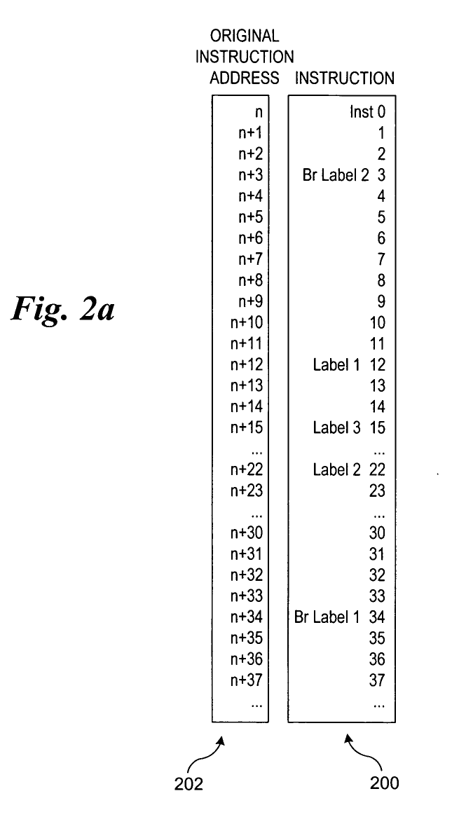

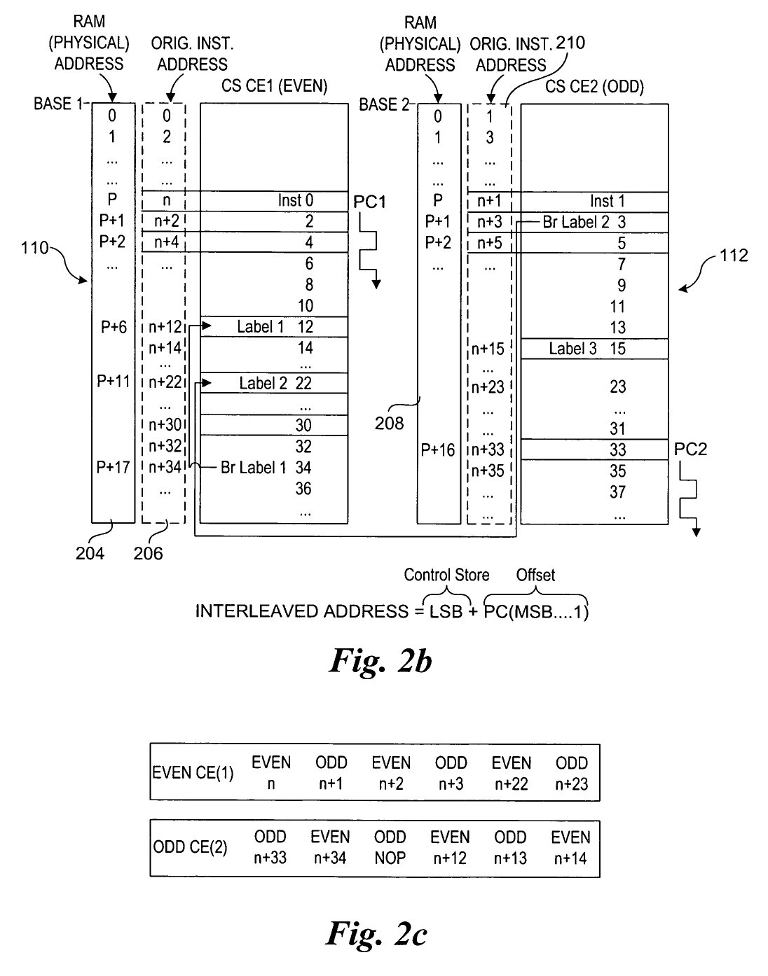

An exemplary portion of a set of instructions corresponding to an instruction thread 200 is shown in FIG. 2a. These instructions are used for illustrative purposes in connection with the figures described below, such that the interleaved instruction schemes may be more easily understood.

As is normally the case, instruction thread 200 includes a set of sequential instructions (with branches) that are loaded and executed in order, except in instances in which an instruction defines a branch operation. For simplicity and clarity, the details for only the branch instructions are depicted in FIG. 2a-all other instructions are simply represented by a sequential instruction number.

The left-hand column in FIG. 2a contains a list of original instruction addresses 202, wherein each address corresponds to a location for its adjacent instruction once the thread is compiled and linked using a conventional sequential storage scheme. The “n” nomenclature is used to illustrate that the physical location of the instructions in memory may begin at some offset n from the base or zeroth address of the memory in which the instructions would be physically stored (if stored in the conventional sequential manner). Original instruction addresses 202 are referred to as “original instruction addresses” for reference purposes. In an actual implementation of the interleaved storage schemes described below, these addresses will not physically exists, but are rather virtual addresses.

FIG. 2b shows exemplary sets of interleaved instructions corresponding to instruction thread 200, wherein the sequential instructions for the thread are stored in an alternating manner in control stores 110 and 112. More specifically, “even” instructions are stored in control store 110 and “odd” instructions are stored in control store 112. In general, control stores 110 and 112 comprise some type of RAM-based memory (e.g., DRAM, SRAM, etc.). Accordingly, each of the control stores contains instructions having a physical (RAM) address. For illustrative purposes, an original instruction address for each instruction is also shown. This represents the ordering of an original instruction thread prior to be partitioned into even and odd sequences to form the alternating interleaved instructions, as described below in further detail.

The physical and original instruction addresses for control store 110 are depicted in a physical address column 204 and an original instruction address column 206, while the physical and original instruction addresses for control store 112 are depicted in a physical address column 208 and an original instruction address column 210. The address values for the physical addresses will depend on the underlying physical addressing scheme. For example, in one embodiment a 32-bit addressing scheme is employed. For convenience, the base physical address for each of control stores 110 and 112 have been depicted at beginning at base addresses BASE 1 and BASE 2, respectively. Meanwhile, the original instruction addresses for each of the control stores have been selected to begin at 0 for control store 110 and at 1 for control store 112.

Under conventional practices, each of control stores 110 and 112 would contain a separate set of sequentially-ordered instructions similar to instruction thread 200, with the instructions being targeted for execution on one of compute engines 102 and 104, respectively. During operation, a first (initial) instruction identified by a program counter (PC) would be loaded into a compute engine, followed by loading and execution of instructions in the sequential order. The sequential load and execution of instructions would continue until any branch operations were required by a given instruction. Under this circumstance, the program counter would be written with the branch target address, or “jump” to the location of a next instruction defined by the branch; this next instruction would be loaded and executed, followed by load and execution of the immediately following instructions in sequence until another branch operation occurs. This process would be repeated until the execution of the instruction thread was completed. Under typical network processor operations, instances of instruction threads are started and completed in an ongoing matter.

In contrast to the foregoing conventional load and execution scheme, the embodiments of FIGS. 1 and 2b take a different approach. Rather than have instructions stored sequentially in a single control store, the original instructions are interleaved by storing even instructions (sequentially) in one control store, while storing odd instructions (sequentially) in the other control store. For example, even instructions (beginning with an instruction 0) for a given program or application thread (depicted as instructions for instruction thread 200) are sequentially stored in control store 110, while the corresponding odd instructions are stored in control store 112. An instruction is defined as even or odd based on the least significant bit (LSB) of its original instruction address. (It is noted that the offset n will always be an even number, such that the number following n in the original instruction address defines whether the instruction is even or odd.)

During operation, a respective program counter is used to locate the next instruction to be loaded and executed by compute engines 102 and 104. In one embodiment, the program counter values are combined with an even-odd-even-odd . . . logic sequence that is applied as inputs to multiplexers 114 and 116 to determine 1) which instruction is the next to be loaded from each control store; 2) which compute engine those instructions are to be loaded into; and 3) whether those instructions may be immediately loaded for execution or if a delay cycle for one of the compute engines needs to be employed to resynchronize the alternating control store instruction load sequence.

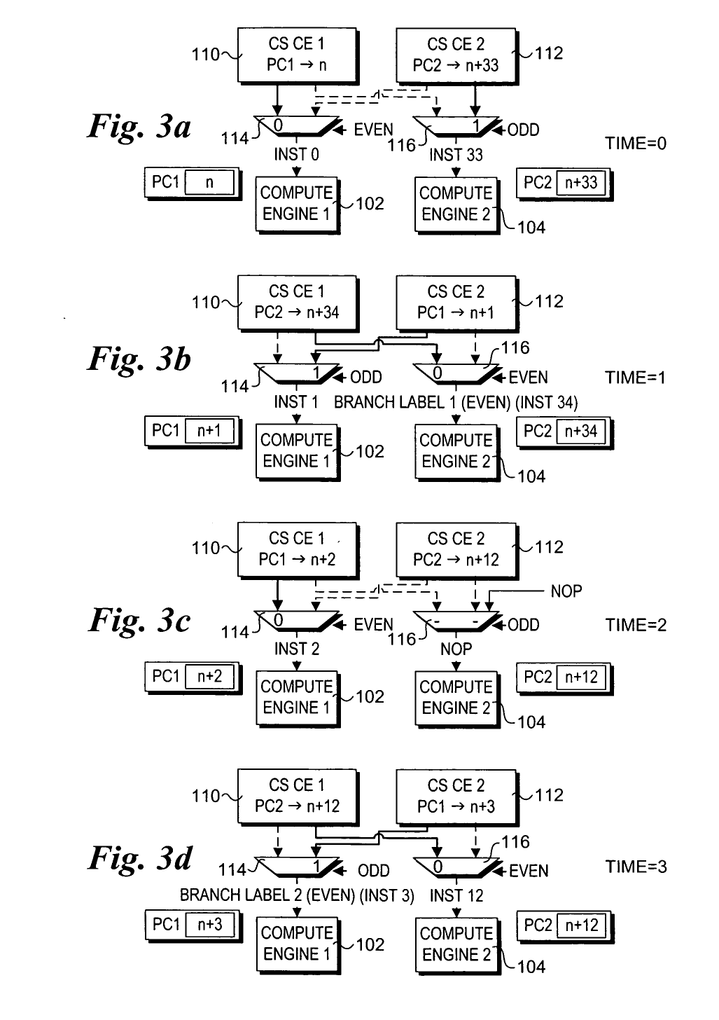

An exemplary execution sequence corresponding to the instructions sequences shown in FIG. 2b are shown in FIG. 2c and schematically illustrated in FIGS. 3a-d. During ongoing operations, each of compute engines 102 and 104 execute multiple instruction threads corresponding to the instructions stored in control stores 110 and 112. The execution of multiple threads is enabled via hardware multithreading, wherein a respective context for each thread is maintained throughout execution of that thread. This is in contrast to the more common type of software-based multithreading provided by modern operating systems, wherein the context of multiple threads is switched using time-slicing, and thus (technically) only one thread is actually executing at any point in time.

In general, hardware multithreading is enabled by providing a set of context registers for each thread. These registers include a program counter for each thread, as well as other registers that are used to store temporal data, such as instructions, operands, etc. However, an independent control store is not provided for each thread. Rather, the instructions for each thread are stored in a single control store. This is enabled by having each thread executing instructions at a different location in the set of instructions at any given point in time, while having only one thread “active” at a time. Furthermore, under a typical pipelined processing scheme, the execution of various packet-processing functions are staged, and the function latency (e.g., amount of time to complete the function) corresponding to a given instruction thread is predictable. Thus, the “spacing” between threads running on a given compute engine stays substantially even, preventing situations under which different hardware threads attempt to access the same instruction at the same time.

For illustrative purposes, the following discussion will concern execution of only a single thread instance on each of compute engines 102 and 104. However, it will be understood that similar operations corresponding to load and execution of other instruction thread instances may be performed (substantially) concurrently on each of the compute engines.

In the example depicted in FIG. 2b, it is assumed the point of execution of a first thread executing on compute engine 102 is at instruction (Inst) 0, as depicted by a program counter PC1. Meanwhile, the point of execution of a second thread executing on compute engine 104 is at an instruction 33, as depicted by a program counter PC2. Instruction 0 is located at an original instruction address of “n” in control store 110, and a physical address “P” from base address BASE 1. In one embodiment, base address BASE 1 is simply 0. Meanwhile, instruction 33 is located at an original instruction address “n”+33 in control store 112, and a physical address of P+15 from base address BASE 2.

FIG. 3a depicts the instruction load at a time point 0 (e.g., an initial point in time at time=0, the condition shown in FIG. 2b). At this point in time, program counter PC1 contains a code sequence value (0) plus the offset n, with the combined value used to identifying the location of the first instruction 0 in control store 110 using a original-to-interleaved address translation scheme described below. Meanwhile, program counter PC2 contains a code sequence value of 33 plus the offset n, which is used identifying the location of instruction 33 in control store 112 using the translation scheme.

In response to each processing cycle that doesn't include an immediately-preceding branch, the instructions pointed to by the program counters PC1 and PC2 are loaded into multiplexers 114 and 116, with one instruction being loaded into one of the multiplexers, while the other instruction is loaded into the other multiplexer. The logic for determining the control store from which each multiplexer is loaded is determined by the EVEN or ODD input to that multiplexer for the given cycle.

During each processing cycle, the EVEN-ODD inputs to each of multiplexers 114 and 116 alternate. Furthermore, the EVEN-ODD inputs for multiplexes 114 and 116 are opposite one-another for each cycle, e.g., one input value is EVEN, while the other input value is ODD. This results in instructions being loaded into a given compute engine from the two control stores in an alternating manner. This alternating sequence continues until a branch operation is encountered, as described in further detail below.

As shown in FIG. 3a, the input for multiplexer 114 is EVEN, or logic “0”, while the input to multiplexer 116 is ODD, or logic “1”. Under the illustrated configuration, a logic 0 input for multiplexer 114 means this multiplexer will load the instruction identified by program counter PC1 from control store 110. Similarly, a logic 1 input for multiplexer 116 will load the instruction identified by program counter PC2 from control store 112. During the next pipelined stage, the instructions stored in multiplexers 114 and 116 are loaded into compute engines 102 and 104, respectively.

As discussed above, each instruction will actually be accessed via its interleaved address, which corresponds to the physical address at which the instruction is actually stored in the applicable control store. The interleaved address, in turn, may be derived from the current PC value, as follows:
INTERLEAVED ADDRESS=LSB+PC(MSB . . . 1) (1).
Under the foregoing equation, the first portion of the interleaved address, which identifies the control store in which the instruction is stored, is derived from the LSB of the original instruction address. The second portion of the interleaved address, which represents the location of the instruction (address) relative to the base address of the control store, may be derived by simply dropping the LSB from the original instruction address using a bit-shift operation, thus leaving all the bits from the most significant bit (MSB) to the second least significant bit. In one embodiment, the base addresses for control stores 110 and 112 (BASE 1 and BASE 2) are not employed during this address translation (e.g., the base address values are simply 0).

Under the scheme illustrated in FIG. 2b,
P=INT(n/2) (2)
wherein P is the physical address (offset) for each of control stores 110 and 112, and the INT function rounds down to the nearest integer. This translation may be performed by doing a simple bit shift to remove the LSB of the PC count value. Thus, the physical address in control store 102 for Inst 0 is P, and the physical address for instruction 33 in control store 112 is P+16.

FIG. 3b shows control store and multiplexer configurations corresponding to a second cycle at time=1. At the conclusion of each cycle, the program counter values are incremented by one (unless a branch instruction exists from the current instruction). Thus the value for program counter PC1 is now n+1, while the value for program counter PC2 is now n+34. Furthermore, program counter PC1 now points to an instruction stored in control store 112, while program counter PC2 points to an instruction stored in control store 110. The program counter count for each thread has simply been incremented by one in the normal manner. However, the control store from which the next instruction for each thread is accessed has been switched. Thus, the new instruction to be loaded and executed on compute engine 102 is an instruction 1 located at physical address P in control store 112. Meanwhile, the new instruction to be loaded and executed on compute engine 104 is an instruction 34 (Br Label 1) located at physical address P+17 in control store 110.

FIG. 3b also shows a situation wherein the instructions in control stores 110 and 112 are loaded into compute engines 104 and 102, respectively, using a cross-connected data path. As before, the logic to determine which control store to load from is provided by the ODD or EVEN inputs to multiplexers 114 and 116. In this instance, an ODD input to multiplexer 114 instructs this multiplexer to load an instruction from control store 112 (the control store that stores the ODD instructions). Similarly, the EVEN input to multiplexer 116 instructs this multiplexer to load an instruction from control store 110 (the control store that stores the EVEN instructions). As a corollary process, the operation of retrieving a next instruction from a given control store places that instruction in an output buffer coupled to the input side of each of multiplexers 102 and 104 (output buffer not shown for clarity).

In connection with the instruction load operations illustrated in FIG. 3b at time=1, an instruction depicted as a branch label instruction is forwarded to multiplexer 116 and then loaded into and executed on compute engine 104. Execution of this instruction, Br Label 1, causes the program counter (PC2) for compute engine 104 to be vectored to the instruction at Label 1 (instruction 12), having an original instruction address n+12. It is noted that the actual instruction will not reference a label, but will rather reference an original instruction address corresponding to the next instruction to jump to.

Continuing with the cycle at a time=2 depicted in FIG. 3c, the next instructions to be loaded are instruction 2 at original instruction address n+2 (physical address P+1 in control store 110) and instruction 12 at original instruction address n+12 (physical address P+6 in control store 110). Under the illustrated embodiment, an instruction may be loaded when the logic level of the multiplexer input and the least significant bit of the original instruction address match. Thus, an even instruction may be loaded into a multiplexer having an EVEN input, while an odd instruction may be loaded into a multiplexer having an ODD input. Accordingly, the instruction load from control store 110 into multiplexer 114 and henceforth to compute engine 102 is allowed to proceed in the normal manner described above. In contrast to the foregoing, an odd instruction may not be loaded into a multiplexer having an EVEN input, and an even instruction may not be loaded into a multiplexer having an ODD input. Thus, instruction 12 at address n+12 may not be loaded into multiplexer 116, since the multiplexer input is ODD, while the instruction is an even instruction.

The reason for this latter rule is to prevent concurrent accesses to the same control store during a given cycle. This is not allowed because each control store only has (or is otherwise associated with) a single output buffer, making it impossible to output more than one instruction at a time.

Under one embodiment, the foregoing situation is remedied by causing one of the compute engines to be delayed for a cycle. In one embodiment, the compute engine corresponding to the instruction sequence that was branched is “stalled” for one cycle by issuing a NOP (no operation) instruction to it, as depicted on the right hand portion of FIG. 3c, where compute engine 104 is issued a NOP instruction from multiplexer 116. As an option, the NOP instruction may be provided via another data path (not shown) rather than via multiplexer 116.

During the cycle shown at time=3 in FIG. 3d, the next instruction in the first execution sequence (Inst 3) located at original instruction address n+3 is loaded into compute engine 102 from control store 112 via multiplexer 114, while instruction 12 is loaded from control store 110 into compute engine 104 via multiplexer 116. Note in this instance that Inst 3 is a branch instruction (Br Label 2) to an even instruction at original instruction address n+22. Under this condition, the instruction sequence is odd instruction, jump to even instruction. Since this follows the EVEN-ODD-EVEN-ODD . . . pattern, the next instruction (Inst 22 at physical address P+11 in control store 110) is allowed to be loaded into compute engine 102 without requiring a delay.

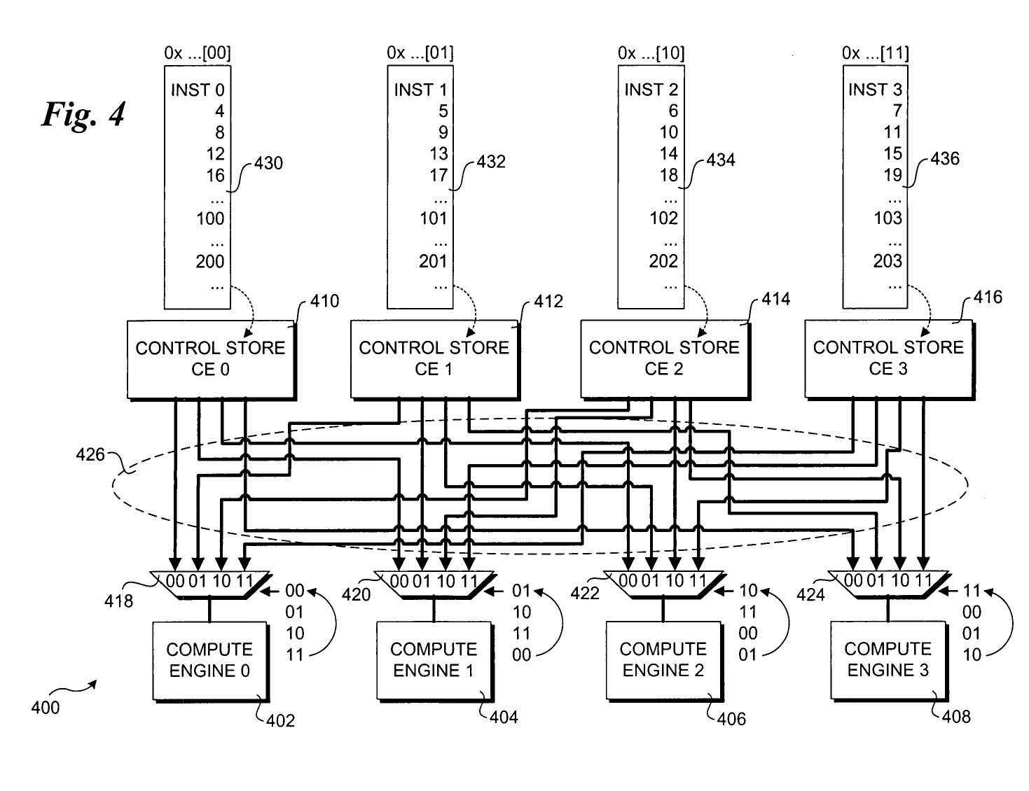

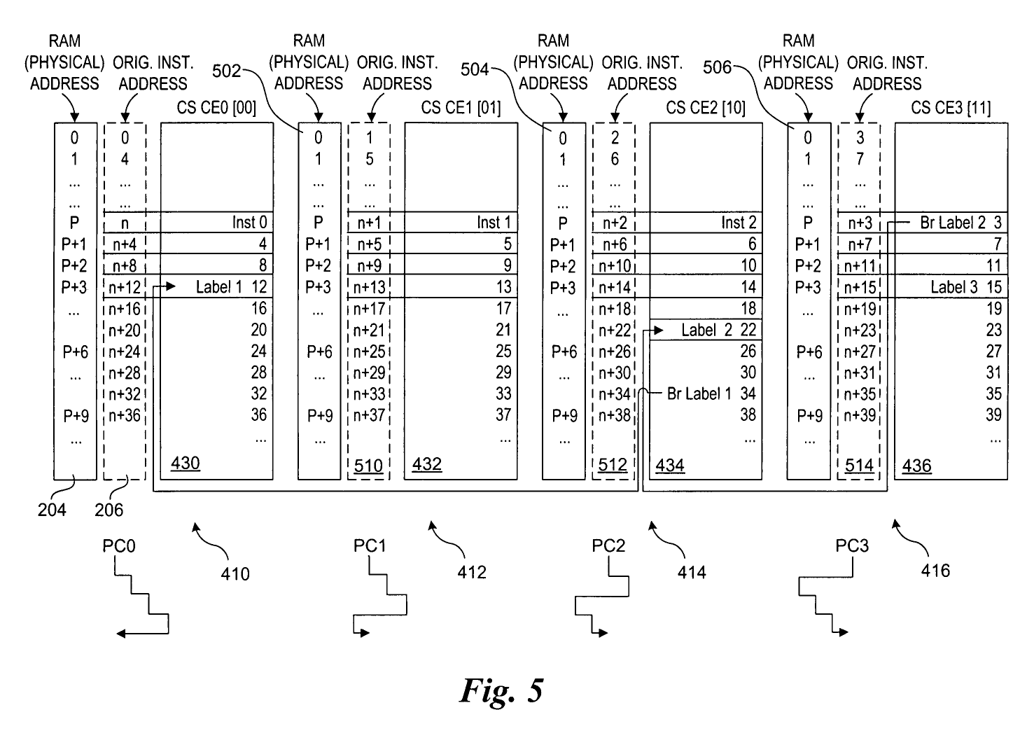

FIG. 4 shows an architecture 400 corresponding to an embodiment of control store sharing scheme that supports sharing four control stores that are shared among four compute engines. Each of compute engines 402, 404, 406 and 408 is coupled to each of control stores 410, 412, 414, and 416 via respective multiplexers 418, 420, 422 and 424 and associated bus lines 426. As shown in further detail in FIG. 5, each of control stores 410, 412, 414, and 416 store portions of interleaved instructions corresponding to instruction thread 200, wherein the instructions are partitioned into four sets based on the least two significant bits in each instructions original instruction address. These instruction sets include an [00] instruction set 430, a [01] instruction set 432, a [10] instruction set 434, and a [11] instruction set 436.

Under the embodiment of FIG. 4, instructions for a given compute engine are loaded from respective control stores in a sequence following the pattern 00, 01, 10, 11, 00, 01, 10, 11 . . . As depicted by the input sequence to each of compute engines 402, 404, 406 and 408, the input sequence is staggered by 1-bit between adjacent compute engines.

Details of the four-way instruction interleave scheme corresponding to the exemplary instruction thread 200 of FIG. 2 are shown in FIG. 5. As before, each instruction in a given control store has a corresponding physical address that is relative to a zeroth base address for the control store. These physical addresses are depicted in physical address columns 500, 502, 504, and 506. As before, virtual addresses corresponding to the original address of instruction thread 200 are shown adjacent to each instruction, as depicted in original instruction address columns 508, 510, 512, and 514. Also as before, the original instruction address columns are not present in an actual implementation, but are rather provided to assist in understanding how the four-way control store sharing scheme operates.

As discussed above, the instructions from instruction thread 200 are partitioned into control stores 420, 432, 434, and 436 based on the least two significant bits of their original instruction addresses. Accordingly, the instruction sequence in each control store skips three instructions (i.e., every fourth instruction is stored), with the original address of the first instruction in each control store being staggered by a single bit. For example, the instructions in [00] control store 430 include the instructions having original instruction addresses that have a value of [00] for their least two significant bits. Thus, the instruction order is 0, 4, 8, 12, 16 . . . with corresponding original instruction addresses of n, n+4, n+8, n+12, n+16 . . . . Similarly, the instruction order in [01] control store 432 contains an ordered list of instructions having original instruction addresses that include [01] for their least two significant bits. Thus, the instruction order in [01] control store 432 is 1, 5, 9, 13, 17 . . . , with corresponding original instruction addresses of n+1, n+5, n+9, n+13, n+17 . . . .

The processing operations employed for loading and executing interleaved instructions under architecture 400 are somewhat analogous to similar operations employed for architecture 100 discussed above. However, in this instance, a given control store is accessed for a given instruction thread instance once every fourth cycle, rather than once every other cycle. For example, if execution of instruction thread 200 is initiated from its starting point on compute engine 402, the instruction sequence load will be Inst 0 from [00] control store 430, Inst 1 from [01] control store 432, Inst 2 from [02] control store 434, Inst 3 from [11] control store 436, etc.

The logic for performing branching is also somewhat analogous to the previous EVEN-ODD-EVEN-ODD . . . scheme. The same requirement for synchronization exists, such that a given control store can only be accessed via a single compute engine (through its multiplexer) during any single cycle. To ensure this exists, a branch to another control store may encounter 0-3 wait cycles, depending on the control stores involved.

For example, suppose that compute engine 404 is currently executing instruction 33, which is located in [01] control store 432. The next instruction (34) is retrieved from [10] control store 434. Following this, the next instruction should be loaded from [11] control store 436, based on the 00, 01, 10, 10 . . . sequence. However, Inst 34 is a branch instruction that jumps execution to instruction 12 stored in [00] control store 430. Since there are two control stores (in the sequence) from the location of Inst 34 and the next instruction to be loaded and executed (Inst 12), a single wait cycle will be employed for compute engine 404 to resynchronize the instruction load sequences.

A similar jump occurs in response to execution of Inst 3 (Br Label 2). In this instance, the next instruction (Inst 22) is located in a control store that is one-place to the left of the branch instruction. As a result, two wait cycles will be employed for the compute engine executing the thread when progressing from Inst 3 to Inst 22.

Following similar logic, when a branch instruction and the jumped-to instruction are located in the same control store, three wait cycles will be employed to resynchronize the instruction load sequence. Conversely, if the jumped-to instruction is located in the control store that is one place to the right of the control store containing the branch instruction, the instruction load may proceed directly without any wait cycles, since this control store is the control store from which the next instruction would normally be loaded from.

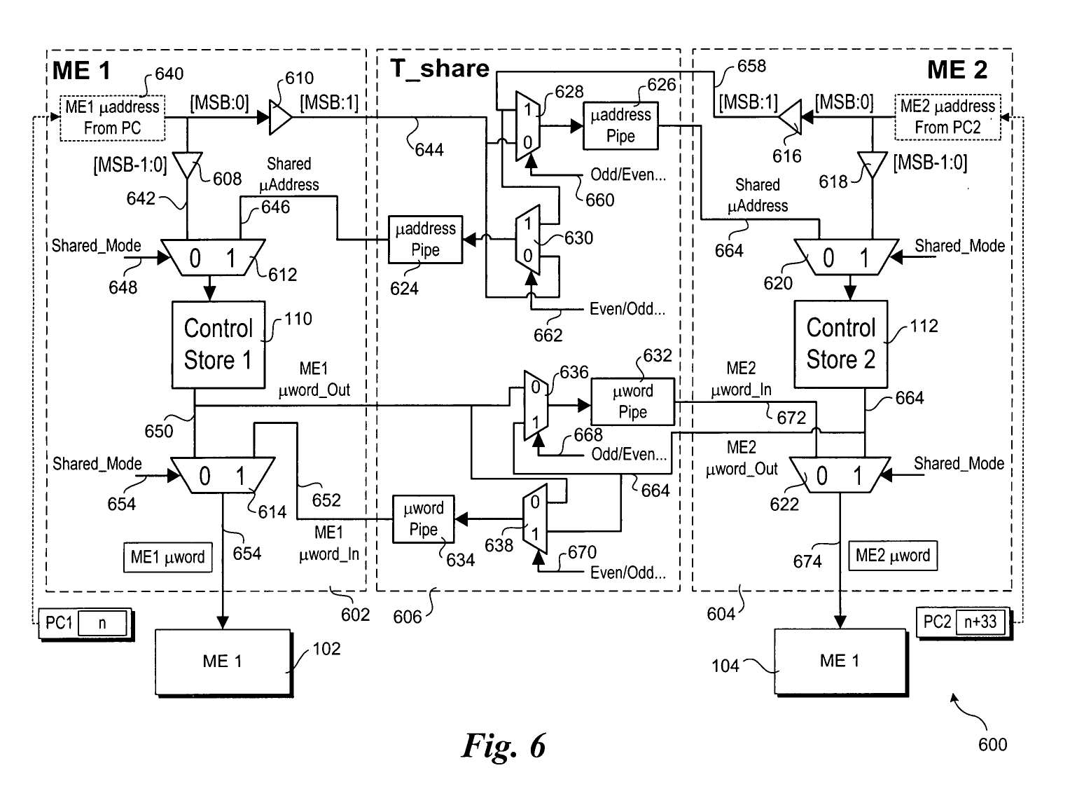

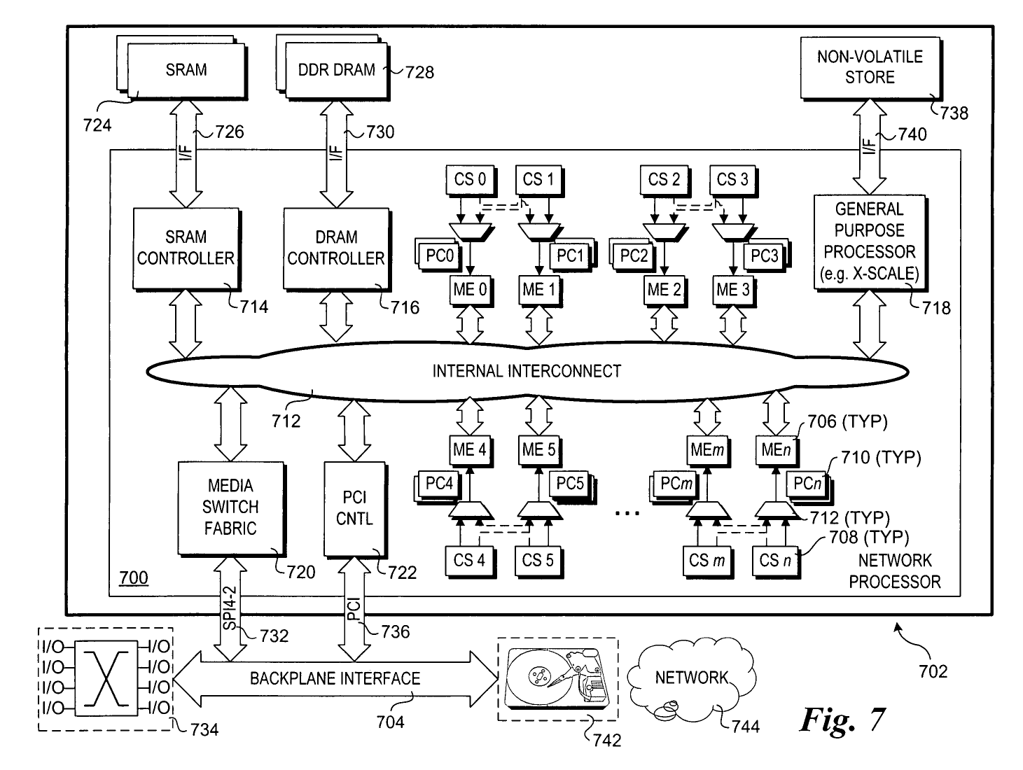

Details of an architecture 600 in accordance with one embodiment for implementing the EVEN-ODD two-way control store sharing scheme discussed above are shown in FIG. 6. Under architecture 600, the aforementioned compute engines 102 and 104 comprise microengines ME 1 and ME 2. A respective set of instruction load logic is provided for each of the microengines, as depicted by an ME 1 instruction load logic block 602 and an ME 2 instruction load logic block 604. Architecture 600 further includes a shared instruction load logic block 606.

ME 1 instruction load logic block 602 includes bit shifters 608 and 610, a multiplexer 612, control store 110, and a multiplexer 614. Similarly, ME 2 instruction load logic block 604 includes bit shifters 616 and 618, a multiplexer 620, control store 112, and a multiplexer 622. Shared instruction load logic block includes microaddress pipe registers 624 and 626, multiplexers 628 and 630, microword pipe registers 632 and 634, and multiplexers 636 and 636.

The operation of the instruction load logic proceeds as follows. As a first example, the operation of an instruction load for microengine ME 1 is described. In one embodiment, the process is initiated by a new cycle activation, in response to a rising clock edge. Immediately prior to this, the value in program counter PC1 is incremented. The PC1 count value, which references the next microaddress 640 to load, is provided as an input to each of bit shifters 608 and 610. Bit shifter 608 drops the MSB of the PC1 count value, so as to produce an address value 642 corresponding to [MSB-1:0]. In contrast, bit shifter 610 shifts all of the bits of the PC1 count value to the right by one, to produce an ME 1 address value 644 includes bits [MSB:1] of the program counter PC1 count value.

The [MSB-1:0] address value 642 is provided as one of the inputs into multiplexer 612, with the other input corresponding to a shared microaddress 646 that is generated by shared instruction load logic block 606. A Shared_Mode control input 648 is provided to multiplexer 612 to control its output. This control input is used as a logic input that defines whether control store sharing is in effect or not in effect. In the illustrated embodiment, a logic 0 Shared_Mode input indicates sharing is turned off, while a logic 1 Shared_Mode input indicates that control stores 110 and 112 are being shared. The other Shared_Mode control inputs depicted in FIG. 6 perform a similar function with respect to their respective multiplexers.

In effect, [MSB-1:0] address value 642 corresponds to the address for a next instruction under a conventional instruction thread storage scheme (e.g., all instructions for the thread are stored in control store 110), while shared address value 646 defines a translated address that is used to locate a next instruction that may be provided to either microengine ME 1 or ME 2, depending on the logic level of the control inputs to the architecture's multiplexers.

The output of multiplexer 612 is provided as an input address to control store 110. In response, an instruction located at the input address is provided as an output microword 650 (e.g., instruction) by control store 110. The output microword is provided as an input to multiplexers 614, 636, and 638. An input microword 652 that is output by shared instruction load logic block 606 is provided as a second input to multiplexer 614. Based on the logic level of Shared_Mode control input 654, either output microword 650 or input microword 652 will be provided as an output microword instruction 656 to microengine ME 1.

Returning to the upper left-hand corner of the diagram, [MSB:1] ME 1 address value 644 is provided as a first input to each of multiplexers 628 and 630. Similarly, a [MSB:1] ME 2 address value 658 output by bit shifter 616 of ME 2 instruction load logic block 604 is provided as second inputs to multiplexers 628 and 630. The outputs value (either [MSB:1] ME 1 address value 644 or [MSB:1] ME 2 address value 644) for multiplexers 628 and 630 will depend on the current values of their respective ODD-EVEN-ODD-EVEN . . . control inputs 660 and 662. In practice, one of these inputs will be EVEN, while the other will be ODD, and the two control inputs will switch logic levels with each alternating cycle.

In one embodiment, the output of multiplexer 630, which comprises shared microaddress 646, is temporarily stored in microaddress pipe register 624 as part of a pipelined staging sequence. Similarly, the output of multiplexer 628, which comprises a shared microaddress 664, is temporarily stored in microaddress pipe register 626 as part of a pipelined staging sequence.

In a manner similar to the generation and use of output microword 650, ME 2 instruction load logic block 604 generates an output microword 666, which Is used as inputs to each of multiplexers 622, 636, and 638. As before, the microwords that will be output by multiplexers 636 and 638 will depend on the logic levels of their respective ODD-EVEN-ODD-EVEN . . . control inputs 668 and 670. These microwords, which respectively comprise ME 1 microword in 652 and an ME 2 microword in 672 are temporally-stored in microword pipe registers 632 and 634 as part of the pipelined staging sequence.

In general, the operation of ME 2 instruction load logic block 604 is analogous to the operation of ME 2 instruction load logic block 602 discussed above. However, in this case, the instruction load process is initiated by the program counter PC2 value, and produces a microword instruction 674 that is provided as the next instruction to be loaded into and executed on microengine ME 2.

FIG. 7 shows an exemplary implementation of a network processor 700 that employs elements of the network processor architectures of FIGS. 1 and 6. In this implementation, network processor 700 is employed in a line card 702. In general, line card 702 is illustrative of various types of network element line cards employing standardized or proprietary architectures. For example, a typical line card of this type may comprises an Advanced Telecommunications and Computer Architecture (ATCA) modular board that is coupled to a common backplane in an ATCA chassis that may further include other ATCA modular boards. Accordingly the line card includes a set of connectors to meet with mating connectors on the backplane, as illustrated by a backplane interface 704. In general, backplane interface 704 supports various input/output (I/O) communication channels, as well as provides power to line card 702. For simplicity, only selected I/O interfaces are shown in FIG. 7, although it will be understood that other I/O and power input interfaces also exist.

Network processor 700 includes n microengines 706, which are analogous to compute engines 102 and 104 of FIG. 1 and microengines ME 1 and ME 2 of FIG. 6. In one embodiment, n=8, while in other embodiment n=16, 24, or 32. Other numbers of microengines 706 may also me used.

In the illustrated embodiment, respective pairs of microengines 706 share corresponding pairs of control stores 708 in the manner depicted by architectures 100 and 600 described above. Each microengine 706 includes a respective set of one or more PC counters 710 (depending on how many concurrent hardware threads are supported), and receives instructions from the output of a respective multiplexer 710. (It will be understood that multiplexers 710 are generally illustrative of the circuitry and logic shown in architecture 600; a single pair of multiplexers are shown here for simplicity.) In another embodiment, control stores may be shared between four microengines using a control store sharing and instruction thread interleaving scheme analogous to those shown in FIGS. 4 and 5. Furthermore, the respective sets of microengines that share control stores may be configured as a single set, or may be clustered in groups of microengines.

Each of microengines 706 is connected to other network processor components via sets of bus and control lines referred to as the processor “chassis”. For clarity, these bus sets and control lines are depicted as an internal interconnect 712. Also connected to the internal interconnect are an SRAM controller 714, a DRAM controller 716, a general purpose processor 718, a media switch fabric interface 720, and a PCI (peripheral component interconnect) controller 722. Other components not shown that may be provided by network processor 700 include, but are not limited to, scratch memory, hash units, encryption units, and a CAP (Control Status Register Access Proxy) unit.

The SRAM controller 714 is used to access an external SRAM store 724 via an SRAM interface 726. Similarly, DRAM controller 716 is used to access an external DRAM store 728 via a DRAM interface 730. In one embodiment, DRAM store 728 employs DDR (double data rate) DRAM. In other embodiment DRAM store may employ Rambus DRAM (RDRAM) or reduced-latency DRAM (RLDRAM).

General-purpose processor 718 may be employed for various network processor operations. In one embodiment, control plane operations are facilitated by software executing on general-purpose processor 718, while data plane operations are primarily facilitated by instruction threads executing on microengines 706.

Media switch fabric interface 720 is used to interface with the media switch fabric for the network element in which the line card is installed. In one embodiment, media switch fabric interface 720 employs a System Packet Level Interface 4 Phase 2 (SPI4-2) interface 732. In general, the actual switch fabric may be hosted by one or more separate line cards, or may be built into the chassis backplane. Both of these configurations are illustrated by switch fabric 734.

PCI controller 722 enables the network processor to interface with one or more PCI devices that are coupled to backplane interface 704 via a PCI interface 736. In one embodiment, PCI interface 736 comprises a PCI Express interface.

During initialization, coded instructions to facilitate the packet-processing functions and operations described above are loaded into control stores 708. In one embodiment, the instructions are loaded from a non-volatile store 738 hosted by line card 702, such as a flash memory device. Other examples of non-volatile stores include read-only memories (ROMs), programmable ROMs (PROMs), and electronically erasable PROMs (EEPROMs). In one embodiment, non-volatile store 738 is accessed by general-purpose processor 718 via an interface 740. In another embodiment, non-volatile store 738 may be accessed via an interface (not shown) coupled to internal interconnect 712.

In addition to loading the instructions from a local (to line card 702) store, instructions may be loaded from an external source. For example, in one embodiment, the instructions are stored on a disk drive 742 hosted by another line card (not shown) or otherwise provided by the network element in which line card 702 is installed. In yet another embodiment, the instructions are downloaded from a remote server or the like via a network 744 as a carrier wave. In general, the instructions for a given thread may be initially stored (e.g., prior to being stored in control stores 708) in an interleaved manner corresponding to the control store sharing scheme, or may be stored in an original instruction thread form and dynamically interleaved in the manner illustrated in FIGS. 2b and 5 above via operations performed by an interleave application running on general-purpose processor 718.

Thus, embodiments of this invention may be used as or to support software/firmware instructions executed upon some form of processing core (such as microengines 706) or otherwise implemented or realized upon or within a machine-readable medium. A machine-readable medium includes any mechanism for storing or transmitting information in a form readable by a machine (e.g., a compute engine). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
coupling each of a plurality of compute engines to a plurality of control stores; and
enabling instances of an instruction thread having respective portions of instructions stored in the plurality of control stores to be executed via respective execution threads running on each of the plurality of compute engines.

2. The method of claim 1, further comprising:
enabling multiple instances of the instruction thread to be executed substantially concurrently on at least one of the plurality of compute engines.

3. The method of claim 1, wherein the plurality of compute engines and control stores comprise first and second compute engines coupled to each of first and second compute stores.

4. The method of claim 3, further comprising:
partitioning alternating instructions for an original instruction thread into even and odd sequences;
storing instructions for the even sequence in the first compute store;
storing instruction for the odd sequence in the second compute store.

5. The method of claim 4, further comprising:
executing an instance of the instruction thread on the first compute engine by loading and executing instructions from the first and second control stores in an alternating manner.

6. The method of claim 5, further comprising:
loading a branch instruction from a first control store;
determining if the branch instruction jumps to an instruction stored in the first or second control store; and
loading the instruction that is jumped to into the first compute engine if the instruction is stored in the second control store, otherwise stalling the loading of the instruction for one cycle to resynchronize the alternating load and execution sequence.

7. The method of claim 1, wherein the plurality of compute engines and control stores are components integrated on a network processor die.

8. The method of claim 7, further comprising:
integrating circuitry on the network processor die to selectively enable execution of a first instruction thread stored in a single control store from among the plurality of control stores to be executed on a first compute engine and to selectively enable a second instruction thread having portions of its instructions stored across multiple control stores to be executed on the first compute engine.

9. The method of claim 1, wherein the plurality of compute engines comprise four compute engines coupled to each of four compute stores.

10. The method of claim 9, further comprising:
partitioning every fourth instruction for an original instruction thread into first, second, third, and fourth sequences; and
storing the instructions that are partitioned in an interleaved manner across the four compute stores by,
storing instructions for the first sequence in a first compute store;
storing instruction for the second sequence in a second compute store;
storing instruction for the third sequence in a third compute store; and
storing instruction for the fourth sequence in the fourth compute store.

11. The method of claim 10, further comprising:
executing an instance of the instruction thread on the first compute engine by loading and executing instructions from the first, second, third, and fourth control stores in an ordered sequence.

12. The method of claim 11, further comprising:
loading a branch instruction from the first control store into the first compute engine;
determining if the branch instruction jumps to an instruction stored in the first, second, third, or fourth control store; and
loading the instruction that is jumped to into the first compute engine if the instruction is stored in the second control store, otherwise stalling the loading of the instruction for one or more cycles to resynchronize the ordered load and execution sequence.

13. The method of claim 1, further comprising:
storing instructions from an original instruction thread having original instruction addresses into the plurality of control stores, the original instruction thread including branch instructions referencing original branch addresses;
loading a branch instruction into a first compute engine;
extracting an original branch address referenced by the branch instruction;
performing an interleaved address translation based on the original branch address to locate the next instruction to load into the first compute engine, the interleaved address translation identifying the control store the next instruction is located in and the address of the next instruction within that control store.

14. The method of claim 13, wherein the instructions for the instruction thread are interleaved across first and second control stores, and the interleaved address translation employs the least significant bit of the original branch address to locate the control store in which the next instruction is stored.

15. The method of claim 13, wherein the instructions for the instruction thread are interleaved across first, second, third, and fourth control stores, and the interleaved address translation employs the least two significant bits of the original branch address to locate the control store in which the next instruction is stored.

16. The method of claim 13, wherein the location of the next instruction within its control store is determined by shifting bits in the original instruction address by n/2 bits, wherein n equals the number of control stores in which the interleaved instructions are stored.

17. An apparatus comprising:
an interconnect comprising a plurality of command and data buses;
a plurality of compute engines, communicatively-coupled to the interconnect;
a plurality of control stores; and
instruction load logic circuitry, operatively-coupled between the plurality of compute engines and plurality of control stores to enable each compute engine to load interleaved instructions corresponding to an instruction thread that are stored in an interleaved manner across the plurality of control stores.

18. The apparatus of claim 17, wherein the plurality of compute engines and control stores comprise sets of first and second compute engines operatively coupled via the instruction load logic circuitry to each of first and second compute stores.

19. The apparatus of claim 17, wherein the plurality of compute engines and control stores comprise sets of first, second, third and fourth control stores operatively-coupled via the instruction load logic circuitry to each of first, second, third, and fourth control stores.

20. The apparatus of claim 17, wherein each of the plurality of compute engines includes a plurality of program counters, and each compute engines supports hardware multithreading.

21. The apparatus of claim 17, further comprising:
a general-purpose processor, communicatively-coupled to the interconnect; and
a non-volatile store, communicatively-coupled to the processor, to store instructions that if executed by the general-purpose processor causes operations to be performed, including,
partitioning an original instruction thread into a plurality of instruction sequences;
storing the instruction sequences in respective control stores in an interleaved manner.

22. The apparatus of claim 17, wherein the instruction load logic includes:
at least one bit shifter for each control store; and
a plurality of multiplexers, coupled to an instruction address input and an instruction output for each of the control stores.

23. A machine-accessible medium, to provide instruction that if executed perform operations comprising:
partitioning an original instruction thread into a plurality of interleaved instruction sequences;
storing the interleaved instruction sequences in respective control stores.

24. The machine-accessible medium of claim 23, to provide further instruction to perform operations comprising:
determining an original instruction address for each instruction in the original instruction thread;
determining a control store in which each instruction is to be stored as a function of its original instruction address; and
determining an address in the control store that is determined at which that instruction it to be stored as a function of its original instruction address.

25. The machine-accessible medium of claim 24, wherein the control store in which each instruction is to be stored is determined as a function of one or more least significant bits for the instruction's original instruction address.

26. A network line card, comprising:
a network processor, including,
a chassis interconnect comprising a plurality of command and data buses;
a plurality of compute engines, communicatively-coupled to the chassis interconnect;
a plurality of control stores; and
instruction load logic circuitry, operatively-coupled between the plurality of compute engines and plurality of control stores to enable each compute engine to load interleaved instructions corresponding to an instruction thread that are stored in an interleaved manner across the plurality of control stores;
a backplane interface; and
a System Packet Level Interface 4 Phase 2 (SPI4-2) media switch fabric interface, comprising a portion of the backplane interface, communicatively coupled to the chassis interconnect.

27. The network line card of claim 26, wherein the plurality of compute engines and control stores comprise sets of first and second compute engines operatively coupled via the instruction load logic circuitry to each of first and second compute stores.

28. The network line card of claim 26, wherein the plurality of compute engines and control stores comprise sets of first, second, third and fourth control stores operatively-coupled via the instruction load logic circuitry to each of first, second, third, and fourth control stores.

29. The network line card of claim 26, further comprising:
a general-purpose processor, communicatively-coupled to the interconnect; and
a non-volatile store, communicatively-coupled to the processor, to store instructions that if executed by the general-purpose processor causes operations to be performed, including,
partitioning an original instruction thread into a plurality of instruction sequences;
storing the instruction sequences in respective control stores in an interleaved manner.

30. The network line card of claim 26, wherein the network processor further includes a static random access memory (SRAM) memory controller with SRAM interface, coupled to the internal interconnect, the line card further including an SRAM store coupled to the SRAM interface.
